(19) United States
(12) Patent Application Publication
(10) Pub. No.: US 2015/0215248 A1
(43) Pub. Date: Jul. 30, 2015

(54) SYSTEM FOR DIRECT PULL INTERNET CONTENT BY/TO ELECTRONIC MAIL OR BY THE SYSTEM

(71) Applicant: Lucia N. Damino, Sylvan Lake, MI (US)

(72) Inventor: Lucia N. Damino, Sylvan Lake, MI (US)

(21) Appl. No.: 14/608,023

(22) Filed: Jan. 28, 2015

Related U.S. Application Data
(60) Provisional application No. 61/947,361, filed on Mar. 3, 2014.
(60) Provisional application No. 61/932,951, filed on Jan. 29, 2014.

(51) Int. Cl. H04L 12/58

(52) U.S. Cl. CPC H04L 51/08

(57) ABSTRACT

A computer system for delivering user email, SMS/MMS text or system prompted internet content via email and a proprietary user interface. The system facilitates the delivery and access of internet available and prepared content whether it a file, text or a link to a web page by using email, SMS/MMs text or the system through an electronic device that communicates over a network to the computer system. The system matches the email, text or system user request and the information sent by a requesting user to content predefined by a sending user to deliver that content. The computer system directly connects users to internet content. The computer system provides the receiving user with internet files, text or web page links that fulfills the receiving user's request for information from the sending user. When the receiving user initiates the request for information, the computer system records the request for that information.

### CROSS-REFERENCE TO RELATED APPLICATIONS

This application claims the benefit of the priority date of U.S. Provisional Patent Application Ser. No. 61/947,361, titled, System for Direct Pull Internet Content by/to Electronic Mail or by the System or Code, filed Mar. 3, 2014, and U.S. Provisional Patent Application Ser. No. 61/932,951, titled, System for Direct Pull Internet Content by/to Electronic Mail or by the System, filed Jan. 29, 2014.

### BACKGROUND OF THE INVENTION

1. Field of the Invention

This invention relates generally to a direct pull of internet content (DPIC) system for automating delivery of internet content to individuals who have initiated a pull through an email or text request or through the system itself and, more particularly, to a DPIC system for delivering internet content to individuals who have initiated a request through an email, code or text request or through the system itself, where the system tracks the content that receiving users have pulled for the purpose of understanding consumer activity, and where users receive activity of specific content that might prompt additional marketing or interaction with that email or text user or system user, and where the content pulled or requested from the internet is subsequently viewable through the user's email, related standard file formats and the system.

2. Discussion of the Related Art

Currently, the direct pull of internet content is typically constrained to a lengthy text string directing the user to the content they might want direct access to. The content that might be pulled, delivered and downloaded is at the sole discretion of website owners. Users may pull content that website owners have designated for access through web browsers either by directly entering a complete address to its direct location or accessing home or embedded pages of the site and navigating to the desired content.

Texting short codes provides a similar concept that allows a user to text to customer designated codes to pull text string content or deliver information within the scope of texting limitations.

The above-described techniques for pulling internet content have disadvantages. For example, there is a reduced availability of the texting global infrastructure. Additionally, marketers, proprietors, product distributors and manufactures require an automated, centralized system for delivering user request content through a more globally and readily available infrastructure.

What is needed is a direct means for smart phone and computing device users to directly access internet content through simplified, direct internet requests with extended response size limits and the more readily available communications infrastructure of the internet versus other, constrained technologies.

### SUMMARY OF THE INVENTION

The present disclosure describes a DPIC system for delivering user email, SMS/MMS text, code and system prompted internet content via email and through a proprietary user interface. The DPIC system facilitates the delivery and access of internet available and prepared content, whether it a file, text or a link to a web page by using email, text or the system, through an electronic device that communicates over a network to the DPIC system, where the user's texting provider allows for texting to email addresses, SMS and MMS texting to be supported. The system matches the email, email or system user request and the information sent by a requesting user to content predefined by a sending user to deliver that content. The DPIC system directly connects users to the requested, predefined internet content. The DPIC system provides the receiving user with internet files, text or web page links that fulfills the receiving user's request for information from the sending user. When the receiving user initiates the request for information, the DPIC system records the request for that information. Later, the DPIC system can be accessed to view all content delivered to a receiving user. The files, text and web page links receipts can vary, however, they are all delivered and tracked online. All of the content associated with the requesting user's email, text, code or system request is delivered electronically.

Additional features of the present invention will become apparent from the following description and appended claims, taken in conjunction with the accompanying drawings.

### BRIEF DESCRIPTION OF THE DRAWINGS

FIG. 1 is a block diagram of an internet content direct pull system and two users;

FIG. 2 is a block diagram of a networked computer system;

FIG. 3 is a flow chart diagram showing a process for a computer system delivering internet content to a receiving user from content predefined by a sending user;

FIG. 4 is a flow chart diagram showing a process that enables a computer system to identify content being requested and tracking the content being delivered; and

FIG. 5 is a flow chart diagram showing a process that provides the receiving user with a mechanism to view his/her content.

### DETAILED DESCRIPTION OF THE EMBODIMENTS

The following discussion of the embodiments of the invention is directed to a DPIC system for the direct pull of internet content from a user invoked email, text or system request and will be described more fully hereinafter with reference to accompanying drawings, in which detailed embodiments are shown and described. These embodiments should not be construed in any way, rather, these embodiments are provided by way of example so that this disclosure will satisfy applicable legal requirements, and is in no way intended to limit the invention, its applications or uses.

The present invention proposes a system and method for providing online direct pull of internet content including activities by a sender of what a receiver of internet content pulls from online and that is tracked online. The sender of data prepares content to be delivered via an online application while marketing its availability through standard marketing practices. The receiver of the data invokes the delivery of email or system information to the sender of data that provokes the delivery of the sender's content. The content that is being prepared for delivery by the sender and the content that is delivered is the same.

The following terminology is defined as used through the disclosure. A system pull is represented by a user invoked activity that initiates the send of information. A code represents a graphical image that when decoded by an electronic reader can be translated to information or commands that subsequently initiate other system processing. Keyword and tag name represent a combination of text strings that correlate to electronic content to be delivered to requesters of information. A text represents a message that is delivered by a short message service (SMS) or multimedia messaging service (MMS) provided by a phone or mobile communications system. An email represents a user or system generated message sent to or received by an intermediary email messaging system that delivers messages or content.

The sender of the data can be any individual citizen, any corporate or legal entity, any government agency or other private or public sector entity desiring expedited internet content for the intent to communicate with a provoker or receiver of data. The direct pull of internet information by and to email, text or through the direct pull system can be used instead of navigating to and through the internet to locate content and in lieu of requesting and receiving content manually either through the internet or by paper delivery.

From a sender's perspective, the direct pull of internet information using the DPIC system as described provides a number of advantages. For example, it eliminates the high cost of paper brochures, flyers and other paper content and costly, cumbersome and technically constrained text short code communications. Further, it provides a technique for engaging large groups of people at a centralized event, such as a sporting event, theatrical production or like gathering, where an event specific voucher or promotion might be offered for direct targeting with follow up marketing, and provides a technique for delivering event specific content, where the event may be a convention or fair, and where specific types of products and services are show-cased and supporting documentation may be immediately desired by the event participants. The electronic capabilities offered by the DPIC system allow receivers to amass event content without the need for its physical transport. Also, content can be immediately delivered at a point of interest to consumers, and a perpetually available application facilitates communications to interested prospects, parties and audiences through a simple tag name/key word and content definition. Further, a written or verbal communications of the tag name and key word facilitates the receipt of content distribution, the pull of content represents a more valuable user engagement over a push of unsolicited content, and no downloaded application is needed because the user accesses their computing device email application and makes their request or the user accesses the internet application directly to make their request, although an independent application may provide like functionality. Also, real estate sale, restaurant menus, store sales events, movie listings, product information, and like content related to point of interest can be immediately pulled, and access to information is simplified and information is pulled at will.

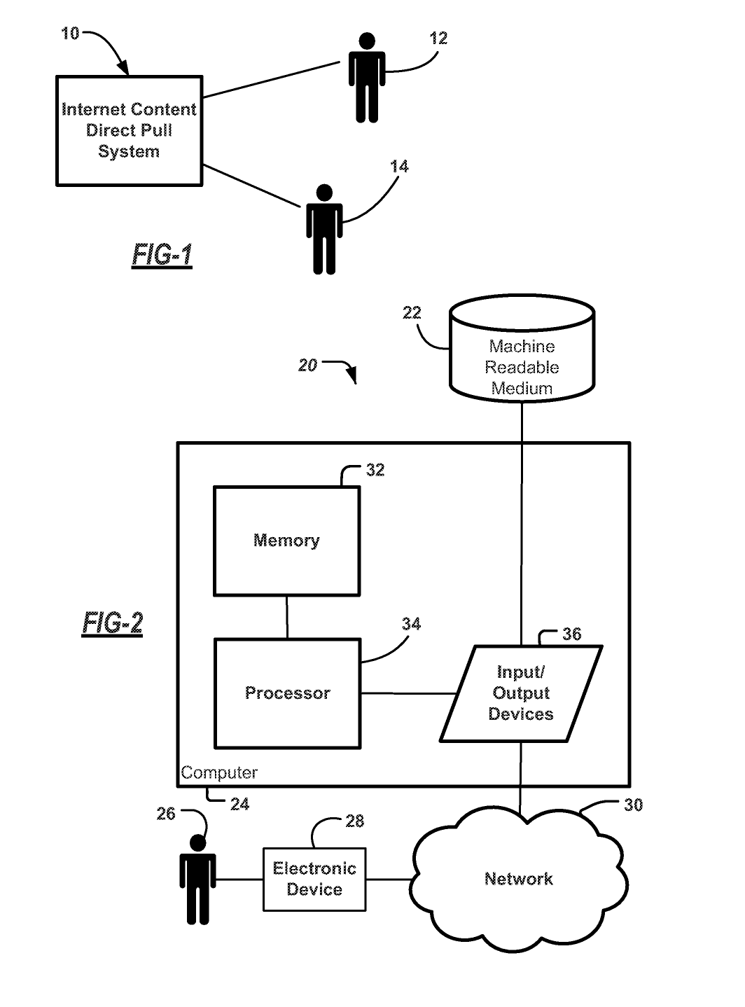

FIG. 1 illustrates a user interactive DPIC system 10 of the type referred to above being in communication with a sending user 12 and a receiving user 14. Although a particular computer architecture for the DPIC system 10 will be described herein, those skilled in the art will recognize variations and alternate approaches that could provide the infrastructure needed to create the special purpose architecture that would necessary for the DPIC system 10.

The DPIC system 10 could be built on or utilize technology such as web/internet portal, website, http, https, web 2.0 technology, internet pages, hosted internet content, internet media, streaming media, programs designed to run in a network computer environment or equivalent technology, or the evolution of such technologies that develop in the future. The DPIC system 10 could be designed to allow access by the general public. The DPIC system 10 could be secured for use by user-defined information, where users input designated credentials to access secured or unsecured content. Examples of such credentials would be a user identification (user-ID) and a password.

FIG. 2 illustrates a networked computer system 20 that illustrates one non-limiting architecture of the DPIC system 10. The system 20 includes a machine readable medium 22, a computer 24, and a user 26, representing either the sending user 12 or the receiving user 14, that can access the computer 24 via an electronic device 28 through a network 30. The computer 24 includes a memory 32, a processor 34, and input/output (I/O) devices 36. The machine readable medium 22 could be a disk drive, a thumb drive, CD, DVD or other device capable of being read by the processor 34 through the I/O devices 36. The machine readable medium 22 contains program instructions and data that can be run on the processor 34 with the memory 32 to create the functionality described herein. The processor 34 communicates with the user 26 using the I/O devices 36 from the network 30.

The network 30 can be the internet, other online networks, other online applications, mobile phone networks or other type of interconnected set of devices, where the internet is the interconnecting set of networks that cover the world, also known as the World Wide Web. The network 30 could be secured or unsecured. The network 30 could be wireless, wired or a combination of both that transmits various standard protocols or proprietary protocols. The network 30 could be an interconnected network of devices that transmits electrical signals to a single user or a group of users. The DPIC system 10 can communicate over the network 30 to and from the sending user 12 and to and from the receiving user 14 by means of electronic documents or other signals that travel on the network 30.

The electronic device 28 could be a personal computer that is running a web browser or other type of hyper text transfer protocol (HTTP) software accessing the DPIC system 10 through a universal record locator (URL). The electronic device 28 could also be a computer, laptop, notebook, mobile phone, tablet computer or similar device, any other device that can provide two-way communications from the user to the DPIC system 10 or any other type of input device that the user can interact with and is capable of communicating over the network 30 to the DPIC system 10. The electronic device 28 could be connected by a wireless signal or cable to the network 30.

The sending user 12 accesses the DPIC system 10 and establishes a user account by, for example, the electronic device 28 that works over the network 30 to communicate with the DPIC system 10. The DPIC system 10 could be made accessible to the sending user 12 and the receiving user 14 on any day and time from the convenience of their home or anywhere using the electronic device 28.

The DPIC system 10 provides electronic monitoring of the receiving user's content. It is in the interest of business intelligence to understand the activity and content interest of the receiving user 14. The sending user 12 may additionally wish to engage with the receiving user 14 with updates or new content at a future date. The content can be delivered in any electronic form, such as written, virtual, audio, video, streaming media, interactive and other current and future electronic forms. The delivery of the content will be through the network 30.

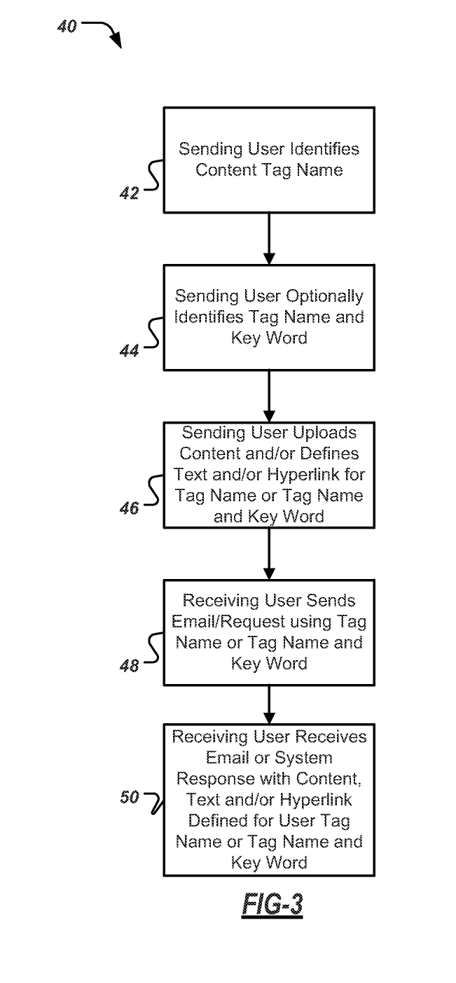

FIG. 3 is a flowchart diagram 40 showing a process where the sending user 12 assigns internet content to a tag name and prospectively to an accompanying key word. As used herein, a tag name denotes the sending user's major grouping for defined content and serves as the sending user's primary interface to the content. Key words may be provided by the receiving user 14 to denote the specific content that he/she might pull. A tag name may or may not have sub-grouping for content defined through the key words. If the receiving user 14 does not provide a key word, then a receiving user's request would pull and deliver default content for the tag name. If the user 14 provides multiple key words, then multiple requests for content are implied and content for each received key word is returned.

The sending user 12 identifies a content tag name at box 42 and optionally identifies a key word for the tag name at box 44. The sending user 12 uploads content and/or identifies text and/or identifies a hyperlink for the tag name or the tag name and the key word at box 46. The receiving user 14 sends an email or system request using the tag name or the tag name and the key word at box 48 to the sending user 12 to provoke the delivery of the content via email or to the system 10. The assigned content may include a file, attachment, text or a link which may be delivered to the user to a specific location in the network 30 or the internet. The receiving user 14 then receives an email or system response with the content, text or the hyperlink defined for the tag name or tag name and the key word at box 50.

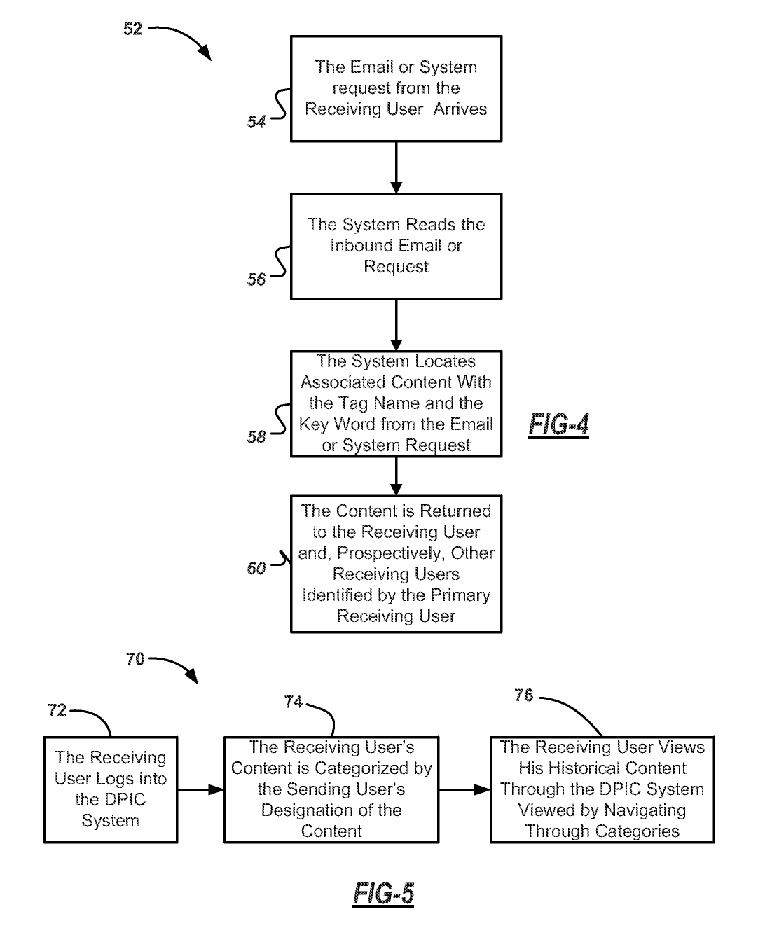

FIG. 4 is a flow chart diagram 52 showing a process that enables a computer system to identify content being requested and tracking the content being delivered, where the email or request from the receiving user 14 arrives and is processed by the DPIC system 10. The process begins with the receipt of the receiving user's email or request at box 54. The process continues at box 56 where the system 10 reads the inbound email or request with the identification of the tag name and any associated key words. The tag name and key word are matched with the sending users designated content at box 58, where the system 10 locates associated content with the tag name and the key word from the request. The designated content is then delivered to the sender of the email or the requester of the content through the DPIC system 10, the receiving user 14, and any other recipients that he may have identified at box 60.

FIG. 5 is a flow chart diagram 70 showing a process that provides the receiving user 14 with a mechanism to view his/her content. Over time, the DPIC system 10 will accrue historical receipts for any given receiving user 14. The receiving user 14 may at any time access the DPIC system 10 for a centralized view of all of the content requests. The sending user 12 through his/her identification of available content may have additionally aligned the content with a category or categories. This category becomes the means for organizing a receiving user's content. As such, once logged into the DPIC system 10, the receiving user 14 may navigate through content categories or receipt dates to locate previously requested content. The receiving user 14 logs into the DPIC system 10 at box 72. The receiving user's content is categorized by the sending user's designation of the content at box 74. The receiving user 14 views his/her historical content through the DPIC system 10 by navigating through categories at box 76.

Give all terms used in the claims their broadest reasonable construction and their ordinary meaning as understood by those skilled in the art. Use of the similar articles such as “a”, “the”, “said”, etc. should be read to recite one or more of the indicated elements.

As will be well understood by those skilled in the art, the several and various steps and processes discussed herein to describe the invention may be referring to operations performed by a computer, a processor or other electronic calculating device that manipulate and/or transform data using electrical phenomenon. Those computers and electronic devices may employ various volatile and/or non-volatile memories including non-transitory computer-readable medium with an executable program stored thereon including various code or executable instructions able to be performed by the computer or processor, where the memory and/or computer-readable medium may include all forms and types of memory and other computer-readable media.

The foregoing discussion disclosed and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

What is claimed is:

1. A method for direct pull of internet content, said method comprising:
providing a computer system including a processor and a memory for executing instructions, said computer system controlling and tracking delivery of the content between a sending user and a requesting user;
assigning by the sending user a tag name to the internet content that defines the content;
uploading the content and/or identifying text and/or identifying a hyperlink using the tag name from the sending user to the computer system;
sending an email, text, code or system request by the requesting user using the tag name to the system that initiates an automated delivery of the content that has been predefined by the sending user to the requesting user through the computer system; and
sending or delivering the internet content to the requesting user by email or to the computer system in response to the request.

2. The method of claim 1 wherein the content is delivered in an electronic form including written, virtual, audio, video, streaming media or interactive forms.

3. The method of claim 1 wherein the content may include a file, attachment, text or a link.

4. The method of claim 1 further comprising accruing historical content requests for the requesting user.

5. The method of claim 4 wherein accruing historical includes categorizing the historical content requests.

6. The method according to claim 1 wherein assigning by the sending user a tag name includes assigning one or more key words associated with the tag name that defines a sub-group of the content.

7. The method of claim 1 wherein the request for the content is made by email or directly from the system.

8. The method of claim 1 wherein the requested content is returned by email or directly to a user's system account.

9. The method of claim 1 wherein an email, text or deciphered code that is received requesting the content is read to determine what internet content is to be delivered.

10. The method of claim 1 further comprising providing electronic monitoring of the delivered content for business intelligence purposes.

11. The method of claim 1 wherein the content is tracked for marketing purposes.

12. A method for direct pull of internet content, said method comprising:
providing a computer system including a processor and a memory for executing instructions, said computer system controlling and tracking delivery of the content between a sending user and a requesting user;
assigning by the sending user a tag name to the internet content that defines the content and assigning one or more key words associated with the tag name that defines a sub-group of the content;
uploading the content and/or identifying text and/or identifying a hyperlink using the tag name and the key word from the sending user to the computer system;
sending an email, text, code or system request by the requesting user using the tag name or the key word to the system that initiates an automated delivery of the content that has been predefined by the sending user to the requesting user through the computer system;
sending or delivering the internet content to the requesting user by email or to the computer system in response to the request, wherein the content is delivered in an electronic form including written, virtual, audio, video, streaming media or interactive forms; and
accruing historical content requests for the requesting user, wherein the content is tracked for marketing purposes.

13. The method of claim 12 wherein the content may include a file, attachment, text or a link.

14. The method of claim 12 wherein accruing historical includes categorizing the historical content requests.

15. The method of claim 12 further comprising providing electronic monitoring of the delivered content for business intelligence purposes.

16. A pull system for direct pull of internet content, said pull system comprising:
a computer system including a processor and a memory, said computer system controlling and tracking delivery of the content between a sending user and a requesting user, said computer system executing instructions that:
allows the sending user to assign a tag name to the internet content that defines the content and assign one or more key words associated with the tag name that defines a sub-group of the content;
uploads the content and/or identifying text and/or identifying hyperlink using the tag name and the key word from the sending user to the computer system;
allows an email, text, code or system request to be sent by the requesting user using the tag name or the key word to the system that initiates an automated delivery of the content that has been predefined by the sending user to the requesting user through the computer system; and
allows the internet content to be sent or delivered to the requesting user by email or to the computer system in response to the request.

17. The pull system of claim 16 wherein the content is delivered in an electronic form including written, virtual, audio, video, streaming media or interactive forms.

18. The pull system of claim 16 wherein the computer system also executes instructions to accrue historical content requests for the requesting user.

19. The pull system of claim 18 wherein the computer system executes instructions to categorize the historical content requests.

20. The pull system of claim 16 wherein the computer system also executes instructions to allow the content to be tracked for marketing purposes.
